(19) United States
(12) Patent Application Publication
(10) Pub. No.: US 2020/0129040 A1
(43) Pub. Date: Apr. 30, 2020

(54) DISHWASHER APPLIANCE WITH A SIDE-FIRE INDICATOR LENS

(71) Applicant: Haier US Appliance Solutions, Inc., Wilmington, DE (US)

(72) Inventor: Kyle James Brewer, Louisville, KY (US)

(21) Appl. No.: 16/171,995

(22) Filed: Oct. 26, 2018

(51) Int. Cl. A47L 15/42; F21V 33/00

(52) U.S. Cl. CPC A47L 15/4293; F21Y 2115/10; F21V 33/0044; A47L 15/4274

(57) ABSTRACT

A dishwasher appliance includes a door hinged to a cabinet. A user interface panel is positioned on the door at a top edge of the door. A user interface board is positioned within the door below the user interface panel. A plurality of capacitive sensors is mounted to the user interface board. The capacitive sensors are operable to detect user inputs on the user interface panel. A user indicator lens is positioned on the door at a front face of the door and below the user interface panel. A daughter board is positioned within the door at the user indicator lens. The user interface board is positioned generally parallel to the daughter board within the door. A plurality of orthogonal light emitting devices is mounted to the daughter board. The orthogonal light emitting devices are oriented to illuminate indicators on the user indicator lens.

### FIELD OF THE INVENTION

The present subject matter relates generally to dishwasher appliances with user inputs and indicators.

### BACKGROUND OF THE INVENTION

Top control dishwasher appliances include a control panel integrated into a top of the dishwasher's door. The control panel may be hidden when the door is closed. Thus, top control dishwasher appliances may provide a sleek appearance relative to front control dishwasher appliances that include a control panel that faces forward when the door is closed.

The sleek appearance of top control dishwasher appliances can have drawbacks. For example, the control panel frequently displays an operational status while the dishwasher appliance is operating, and a user can have difficulty viewing the control panel on top control dishwasher appliances when the door is closed and the dishwasher is operating. Thus, it can be difficult for the user to determine the current operational status of top control dishwasher appliances while the door is closed and the control panel is hidden.

Known top control dishwasher appliances include front indication that is operable to present the current operational status on a front panel. Thus, the user can more easily determine the current operational status via the front indication. However, wiring and mounting the front indication within the door can be difficult.

### BRIEF DESCRIPTION OF THE INVENTION

Aspects and advantages of the invention will be set forth in part in the following description, or may be apparent from the description, or may be learned through practice of the invention.

In a first example embodiment, a dishwasher appliance includes a cabinet that defines a wash chamber. A door is mounted to the cabinet such that the door is openable and closable to selectively seal the wash chamber. A user interface panel is positioned on the door at a top edge of the door. A user interface board is positioned within the door below the user interface panel. A plurality of capacitive sensors is mounted to the user interface board. The capacitive sensors are operable to detect user inputs on the user interface panel. A user indicator lens is positioned on the door below the user interface panel. A daughter board is positioned within the door at the user indicator lens. The user interface board is positioned generally parallel to the daughter board within the door. A plurality of side-fire light emitting diodes is mounted to the daughter board. The side-fire light emitting diodes are oriented to illuminate indicators on the user indicator lens.

In a second example embodiment, a dishwasher appliance includes a cabinet that defines a wash chamber. A door is hinged to the cabinet adjacent a bottom edge of the door such that the door is openable and closable to selectively seal the wash chamber. A user interface panel is positioned on the door at a top edge of the door. A user interface board is positioned within the door below the user interface panel. A plurality of capacitive sensors is mounted to the user interface board. The capacitive sensors are operable to detect user inputs on the user interface panel. A user indicator lens is positioned on the door at a front face of the door and below the user interface panel. A daughter board is positioned within the door at the user indicator lens. The user interface board is positioned generally parallel to the daughter board within the door. A plurality of orthogonal light emitting devices is mounted to the daughter board. The orthogonal light emitting devices are oriented to illuminate indicators on the user indicator lens.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front elevation view of a dishwasher appliance according to an example embodiment of the present subject matter.

FIG. 2 is a partial perspective view of a door of the example dishwasher appliance of FIG. 1.

FIG. 3 is a partial section view of the door of the example dishwasher appliance of FIG. 1.

FIG. 4 is a side, partial elevation view of a bracket and daughter board of the example dishwasher appliance of FIG. 1.

FIG. 5 is a bottom, partial plan view of the bracket and daughter board of FIG. 4.

FIG. 6 is a partial perspective view of a bracket and daughter board according to another example embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

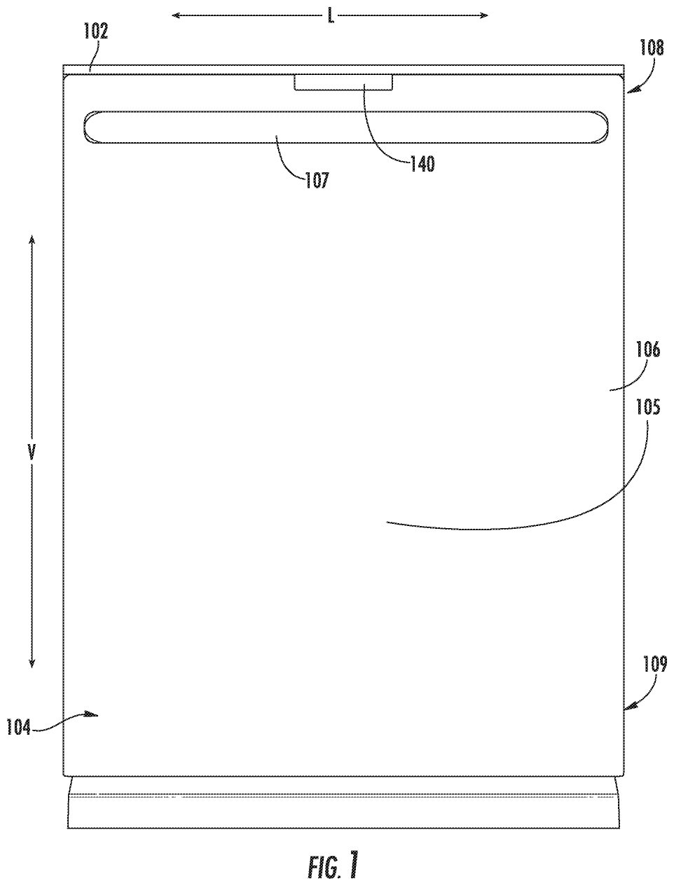

FIG. 1 depicts an example domestic dishwasher appliance 100 that may be configured in accordance with aspects of the present disclosure. It should be appreciated that the invention is not limited to any particular style, model, or other configuration of dishwasher, and that the embodiment depicted in FIG. 1 is for illustrative purposes only.

Dishwasher appliance 100 includes a tub 102 that defines a wash chamber 104 within an interior of tub 102. Wash chamber 104 is configured for the receipt of articles for cleaning, such as dishes, cups, utensils, etc. Tub 102 includes a front opening (not shown) and a door 106 with a handle 107. Door 106 extends between a top portion 108 and a bottom portion 109 along a vertical direction V, and door 106 is hinged at or near bottom portion 109 of door 106 for movement between a normally closed vertical position (shown in FIG. 1), wherein wash chamber 104 is sealed shut for washing operation, and a horizontal open position for loading and unloading of articles from wash chamber 104.

Dishwasher appliance 100 includes various components for applying wash fluid onto articles within wash chamber 104 and for supporting the articles within wash chamber 104. Such components are well known in the art and not shown or described in detail herein. As an example, dishwasher appliance 100 may include racks for supporting articles for washing within wash chamber 104, spray assemblies for directing flows of wash fluid onto the articles within the racks, silverware baskets, etc. The racks may be adapted for movement between an extended loading position in which the racks are substantially positioned outside wash chamber 104, and a retracted position in which the racks are located inside wash chamber 104. The spray assemblies may include rotatable spray arms mounted to tub 102 and/or one or the racks.

In general, dishwasher appliance 100 may utilize a variety of cycles to wash and, optionally, dry articles within wash chamber 104. For example, a wet cycle is utilized to wash articles. The wet cycle may include a main wash cycle and a rinse cycle, as well as an optional pre-wash cycle. During each such cycle, water or another suitable liquid may be utilized in wash chamber 104 to interact with and clean articles therein. The liquid may additionally mix with, for example, detergent or other various additives which are released into the chamber during various sub-cycles of the wet cycle. A drying cycle may be utilized to dry articles after washing. In generally, no liquid is sprayed or otherwise produced during the drying cycle.

During the drying cycle, liquid water on the articles within wash chamber 104 evaporates. The water vapor is flowable out of wash chamber 104 in order to improve drying performance of dishwasher appliance 100. Dishwasher appliance 100 includes various features for flowing air and water vapor from wash chamber 104, e.g., during drying cycles. Such features may improve performance of dishwasher appliance 100.

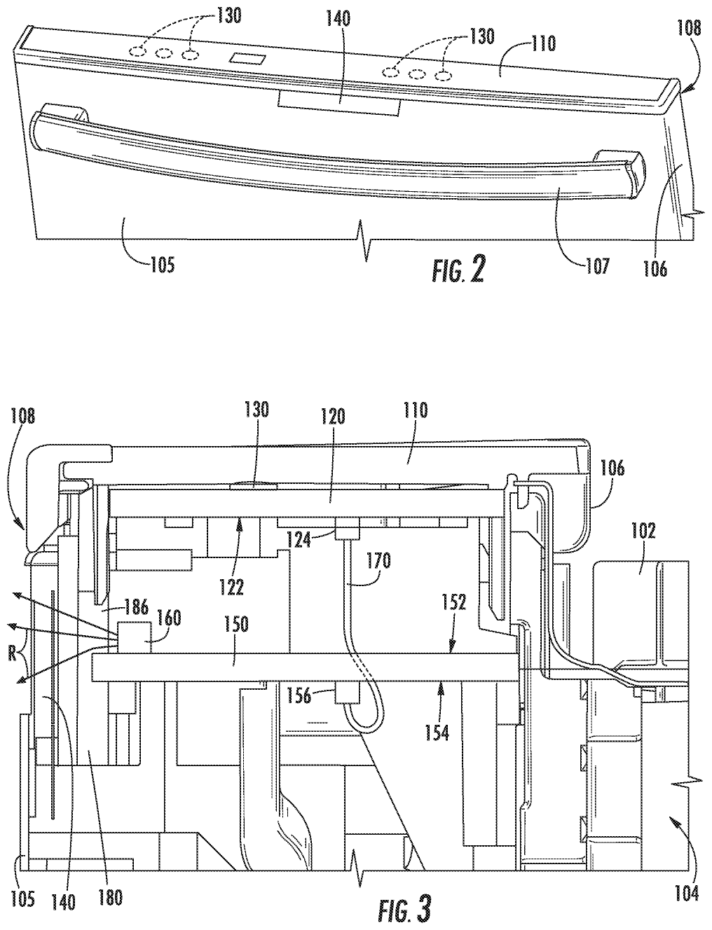

FIG. 2 is a partial perspective view of door 106. FIG. 3 is a partial section view of door 106. As may be seen in FIGS. And 3, dishwasher appliance 100 includes a user interface panel 110. User interface panel 110 is positioned on door 106, e.g., at a top edge 111 of door 106. Thus, e.g., user interface panel 110 may be hidden below a countertop when dishwasher appliance 100 is installed below the countertop and door 106 is closed. Accordingly, dishwasher appliance 100 may be referred to as a “top control dishwasher appliance.” User interface panel 110 may be constructed of or with a dielectric material, such as glass or plastic.

User interface panel 110 is also positioned on door 106 such that a user can engage, e.g., touch, user interface panel 110. Thus, the user can activate/deactivate various cycles of dishwasher appliance 100 using user interface panel 110. In particular, dishwasher appliance 100 includes a user interface board 120 and a plurality of capacitive sensors 130 as shown in FIG. 3. User interface board 120 may be a printed circuit board and be positioned within door 106 below user interface panel 110. Capacitive sensors 130 are mounted to user interface board 120, and capacitive sensors 130 are operable to detect user inputs on user interface panel 110. For example, capacitive sensors 130 may be configured for triggering when a user touches a top surface 112 of user interface panel 110. In particular, capacitive sensors 130 can detect when a finger or another conductive material with a dielectric different than air contacts or approaches user interface panel 110. When a user touches top surface 112 of user interface panel 110 adjacent one of capacitive sensors 130, such capacitive sensor 130 triggers and, e.g., signals a controller (not shown). In such a manner, operations of dishwasher appliance 100 can be initiated and controlled. Capacitive sensors 130 may be distributed laterally on user interface board 120 below user interface panel 110. Thus, while only one of capacitive sensors 130 is shown in FIG. 3, it will be understood that other capacitive sensors 130 are positioned behind the capacitive sensor 130 shown in FIG. 3.

The controller regulates operation of dishwasher appliance 100. Thus, the controller is in operative communication with various components of dishwasher appliance 100, such as a pump, a temperature sensor, a fill sensor, a turbidity sensor, etc. The controller includes memory and one or more processing devices such as microprocessors, CPUs or the like, such as general or special purpose microprocessors operable to execute programming instructions or micro-control code associated with operation of dishwasher appliance 100. The memory can represent random access memory such as DRAM, or read only memory such as ROM or FLASH. The processor executes programming instructions stored in the memory. The memory can be a separate component from the processor or can be included onboard within the processor. Alternatively, the controller may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Dishwasher appliance 100 also includes a user indicator lens 140, a daughter board 150 and a plurality of orthogonal light emitting devices 160. User indicator lens 140 is positioned on door 106 below the user interface panel 110. In particular, user interface panel 110 may be positioned at a front face 105 of door 106. The front face 105 of door 106 may face towards a user of dishwasher appliance 100 when door 106 is closed and may thus correspond to the outermost or visible panel of door 106. Front face 105 of door 106 may be constructed of stainless steel, painted steel, etc. in order to have a pleasant cosmetic appearance. User indicator lens 140 may include be constructed of or with a transparent or translucent panel with a film or printing that forms symbols, words, etc. that are visible from front face 105 of door 106 when illuminated by orthogonal light emitting devices 160 within door 106. Thus, user indicator lens 140 may show one or more operational indicators on user indicator lens 140 to a user looking at door 106 when one or more operational indicators on user indicator lens 140 are illuminated by orthogonal light emitting devices 160 within door 106. In contrast, user indicator lens 140 may be dead fronted when orthogonal light emitting devices 160 are deactivated and not illuminating operational indicators on user indicator lens 140.

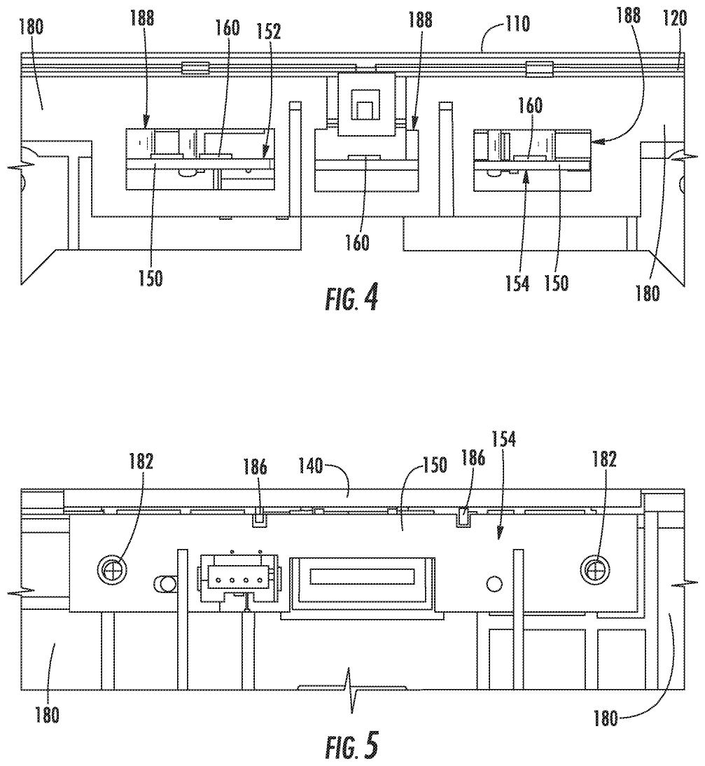

Daughter board 150 may be a printed circuit board and be positioned within door 106 at user indicator lens 140. Orthogonal light emitting devices 160 are mounted to daughter board 150, and orthogonal light emitting devices 160 are oriented to illuminate indicators on user indicator lens 140. In particular, orthogonal light emitting devices 160 are operable to direct light R (FIG. 3) from within door 106 towards and/or through user indicator lens 140. In the example embodiment shown in FIGS. 3 and 4, orthogonal light emitting devices 160 are shown as side-fire light emitting diodes (LEDs). However, in alternative example embodiments, the orthogonal light emitting devices can be any suitable device for emitting light R, e.g., such that light R is substantially perpendicular to a line that is normal to a top surface 152 or a bottom surface 154 of daughter board 150. For example, orthogonal light emitting devices 160 can be top-view LEDs or reverse-mount LEDs with light redirecting devices, such as reflectors, lenses, or fiber optic cables, that redirect light R, e.g., such that light R is substantially perpendicular to a line that is normal to top or bottom surfaces 152, 154 of daughter board 150.

User interface board 120 may be positioned generally parallel to daughter board 150 within door 106. In particular, both user interface board 120 and daughter board 150 may be oriented horizontally when door 106 is closed. As used herein, the term “generally” means within ten degrees of the stated angle when used in the context of board orientations. Arranging user interface board 120 and daughter board 150 in a generally parallel configuration can facilitate installation of user interface board 120 and daughter board 150 within door 106. For example, such arrangement is advantageous from an assembly standpoint in that all fasteners and/or harness connectors may have a common orientation.

As shown in FIG. 3, dishwasher appliance 100 may also include a harness 170. Harness 170 electrically connects or couples user interface board 120 and daughter board 150. For example, user interface board 120 may include a connector 124 at a bottom surface 122 of user interface board 120, and daughter board 150 may include a connector 156 at bottom surface 154 of daughter board 150. Bottom surface 122 of user interface board 120 may face top surface 152 of daughter board 150 within door 106, and bottom surface 154 of daughter board 150 may be positioned opposite top surface 152 of daughter board 150 on daughter board 150. Harness 170 may be connected to user interface board 120 with connector 124 at bottom surface 122 of user interface board 120, and harness 170 may be connected to daughter board 150 with connector 156 at bottom surface 154 of daughter board 150. Harness 170 may extend between connector 124 at bottom surface 122 of user interface board 120 and connector 156 at bottom surface 154 of daughter board 150 to directly couple user interface board 120 and daughter board 150. For example, daughter board 150 may be vertically spaced from user interface board 120 by no less than a half inch (0.5″) when door 106 is closed. Harness 170 may span the vertical gap between user interface board 120 and daughter board 150. In such a manner, user interface board 120 and daughter board 150 may be advantageously coupled to each other without requiring a harness down front face 105 of door 106 with expensive wire and connectors.

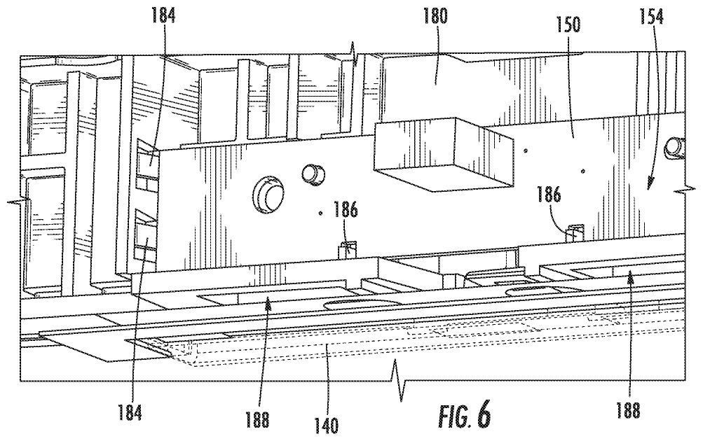

FIG. 4 is a side, partial elevation view of a bracket 180 and daughter board 150. FIG. 5 is a bottom, partial plan view of bracket 180 and daughter board 150. Bracket 180 is positioned within door 106, and bracket 180 may constructed of or with injection molded plastic or another suitable material. User interface board 120 and daughter board 150 may be mounted to bracket 180 within door 106. Thus, user interface board 120 and daughter board 150 may be mounted to a common structure within door 106 in order to assist with arranging user interface board 120 and daughter board 150 in the generally parallel configuration.

User interface board 120 and daughter board 150 may be mounted to bracket 180 in any suitable manner. For example, daughter board 150 may be fastened to bracket 180 as shown in FIG. 5, and user interface board 120 may be mounted to user interface panel 110 that is mounted (e.g., fastened) to bracket 180. In particular, e.g., fasteners 182 may extend through daughter board 150 into bracket 180 in order to mount daughter board 150 to bracket 180. Alternatively, as shown in FIG. 6, daughter board 150 may be snap-fit to bracket 180, and user interface board 120 may be mounted to user interface panel 110 that is mounted (e.g., snap-fit) to bracket 180. In particular, e.g., bracket 180 may a plurality of snap-fit interfaces 184, and daughter board 150 may be snap-fit onto bracket 180 with snap-fit interfaces 184 in order to mount daughter board 150 to bracket 180. As may be seen from the above, user interface board 120 may be mounted to bracket 180 via user interface panel 110 that is mounted to bracket 180.

Bracket 180 may also include a plurality of ribs 186. Each rib 186 may be positioned between a respective pair of orthogonal light emitting devices 160 to block light transmission between the respective pair of orthogonal light emitting devices 160. Thus, only the desired one or more indicators on user indicator lens 140 may be illuminated by orthogonal light emitting devices 160. Bracket 180 may also define a plurality of laterally spaced openings 188, and each of orthogonal light emitting devices 160 may be aligned with a respective laterally spaced opening 188 in order to assist with limiting light bleed from orthogonal light emitting devices 160 between adjacent operational indicators on user indicator lens 140.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance, comprising:
a cabinet defining a wash chamber;
a door mounted to the cabinet such that the door is openable and closable to selectively seal the wash chamber;
a user interface panel positioned on the door at a top edge of the door;
a user interface board positioned within the door below the user interface panel;
a plurality of capacitive sensors mounted to the user interface board, the plurality of capacitive sensors operable to detect user inputs on the user interface panel;
a user indicator lens positioned on the door below the user interface panel;
a daughter board positioned within the door at the user indicator lens, the user interface board positioned generally parallel to the daughter board within the door; and
a plurality of side-fire light emitting diodes mounted to the daughter board, the plurality of side-fire light emitting diodes oriented to illuminate indicators on the user indicator lens.

2. The dishwasher appliance of claim 1, further comprising a bracket positioned within the door, the user interface panel and the daughter board mounted to the bracket, the user interface board mounted to the user interface panel.

3. The dishwasher appliance of claim 2, wherein the daughter boards is snap-fit to the bracket.

4. The dishwasher appliance of claim 2, wherein the daughter boards is fastened to the bracket.

5. The dishwasher appliance of claim 2, wherein the bracket includes a plurality of ribs, each rib positioned between a respective pair of the plurality of side-fire light emitting diodes to block light transmission between the respective pair of the plurality of side-fire light emitting diodes.

6. The dishwasher appliance of claim 1, further comprising a harness that electrically connects the user interface board and the daughter board.

7. The dishwasher appliance of claim 6, wherein the harness is connected to the user interface board at a bottom surface of the user interface board, and the harness is connected to the daughter board at a bottom surface of the daughter board.

8. The dishwasher appliance of claim 1, wherein the user indicator lens is dead fronted when the plurality of side-fire light emitting diodes are deactivated.

9. The dishwasher appliance of claim 1, wherein the daughter board is vertically spaced from the user interface board by no less than a half inch when the door is closed.

10. A dishwasher appliance, comprising:
a cabinet defining a wash chamber;
a door hinged to the cabinet adjacent a bottom edge of the door such that the door is openable and closable to selectively seal the wash chamber;
a user interface panel positioned on the door at a top edge of the door;
a user interface board positioned within the door below the user interface panel;
a plurality of capacitive sensors mounted to the user interface board, the plurality of capacitive sensors operable to detect user inputs on the user interface panel;
a user indicator lens positioned on the door at a front face of the door and below the user interface panel;
a daughter board positioned within the door at the user indicator lens, the user interface board positioned generally parallel to the daughter board within the door; and
a plurality of orthogonal light emitting devices mounted to the daughter board, the plurality of orthogonal light emitting devices oriented to illuminate indicators on the user indicator lens.

11. The dishwasher appliance of claim 10, further comprising a bracket positioned within the door, the user interface panel and the daughter board mounted to the bracket, the user interface board mounted to the user interface panel.

12. The dishwasher appliance of claim 11, wherein the daughter boards is snap-fit to the bracket.

13. The dishwasher appliance of claim 11, wherein the daughter boards is fastened to the bracket.

14. The dishwasher appliance of claim 11, wherein the bracket includes a plurality of ribs, each rib positioned between a respective pair of the plurality of orthogonal light emitting devices to block light transmission between the respective pair of the plurality of orthogonal light emitting devices.

15. The dishwasher appliance of claim 10, further comprising a harness that electrically connects the user interface board and the daughter board.

16. The dishwasher appliance of claim 15, wherein the harness is connected to the user interface board at a bottom surface of the user interface board, and the harness is connected to the daughter board at a bottom surface of the daughter board.

17. The dishwasher appliance of claim 10, wherein the user indicator lens is dead fronted when the plurality of orthogonal light emitting devices are deactivated.

18. The dishwasher appliance of claim 10, wherein the daughter board is vertically spaced from the user interface board by no less than a half inch when the door is closed.
